(19) United States
(12) Patent Application Publication
(10) Pub. No.: US 2010/0189982 A1
(43) Pub. Date: Jul. 29, 2010

(54) Fire and SAG resistanct acoustical panel

(76) Inventors: Anthony L. Wiker, Lancaster, PA (US); Michelle X. Wang, Lititz, PA (US); John H. Gearhart, Chesterfield, MO (US)

Correspondence Address: ARMSTRONG WORLD INDUSTRIES, INC.;LEGAL DEPARTMENT, P. O. BOX 3001, LANCASTER, PA, 17604-3001, US

(21) Appl. No.: 12/590,874

(22) Filed: Nov. 16, 2009

Related U.S. Application Data
(60) Provisional application No. 61/114,778, filed on Nov. 14, 2008.

(51) Int. Cl. B32B 21/02; E04F 13/16; E04B 1/94; B27K 3/20; B32B 27/04

(52) U.S. Cl. 428/220; 442/58; 428/221

(57) ABSTRACT

A ceiling panel structure which includes a fire retardant mat. The fire retardant mat includes a fire retardant fiber component and a binder material which binds the fibers. The fire retardant fiber component includes natural fibers treated with a fire retardant. The ceiling panel structure has flame spread index of 25 or less and a smoke generation index of 50 or less, as measured by ASTM E 84 that is uniform throughout the mat.

### CROSS REFERENCE TO RELATED APPLICATION

This application claims the benefit under 35 U.S.C. §119(e) of U.S. provisional application Ser. No. 61/114,778, filed Nov. 14, 2008, entitled “Fire Retardant Mat And Ceiling Tile Structure Incorporating The Same.”

### BACKGROUND OF THE INVENTION

The present invention is directed to fire and sag resistant panel, and, more particularly, to an enhanced fire rated, sag resistant acoustical ceiling panel having an enhanced fire rated natural fiber mat incorporated therein.

Natural fibers such as hemp, kenaf, jute, sisal and flax, are gaining interest as a component in a variety of manufactured products, including products for the interior building environment, as natural fibers are a renewable resource and do not emit potentially hazardous materials into the environment. Though renewable and environmentally friendly, natural fibers, and the binder material which holds the fibers together, are highly flammable.

Articles intended for use specifically in a construction which is utilized as a conduit for return air must achieve an exceptional Class A fire resistance rating: namely a flame spread index value of 25 or less and a smoke generation index value of 50 or less, as measured by ASTM E 84. Additionally, when an article is suspended horizontally in a room space, such as in an acoustical ceiling system, not only must the efficacy of any flame retardant applied to natural fibers be substantial but it is also desired that these panels be: highly acoustically permeable; dimensionally stable; self-supporting; and sag resistant with respect to fluctuations in relative humidity. As one of ordinary skill in the art would understand, increasing the amount of binder to improve such features as the self-supporting nature of the fibrous mass, in turn, makes the fibrous article more flammable. As a result of such inverse relationships, an article possessing a combination of the aforementioned properties has not been heretofore achieved.

### SUMMARY OF THE INVENTION

The invention is a ceiling panel structure which includes a fire retardant mat. The fire retardant mat includes a fire retardant fiber component and a binder material which binds the fibers. The fire retardant fiber component includes natural fibers treated with a fire retardant. The fire retardant mat has flame spread index of 25 or less and a smoke generation index of 50 or less, as measured by ASTM E 84 that is uniform throughout the mat. The ceiling panel structure also includes a scrim attached to the bottom surface of the fire retardant mat as well as a coating on the exposed surface of the scrim opposite the fire retardant mat. The ceiling panel structure also achieves a flame spread index value of 25 or less and a smoke generation index value of 50 or less, as measured by ASTM E 84 that is uniform throughout the structure.

### BRIEF DESCRIPTION OF THE DRAWINGS

FIG. 1 is a side view of a fire retardant mat according to an embodiment of the invention.

FIG. 2 is a side view of a ceiling panel structure incorporating the fire retardant mat of FIG. 1.

### DETAILED DESCRIPTION OF THE EMBODIMENT(S)

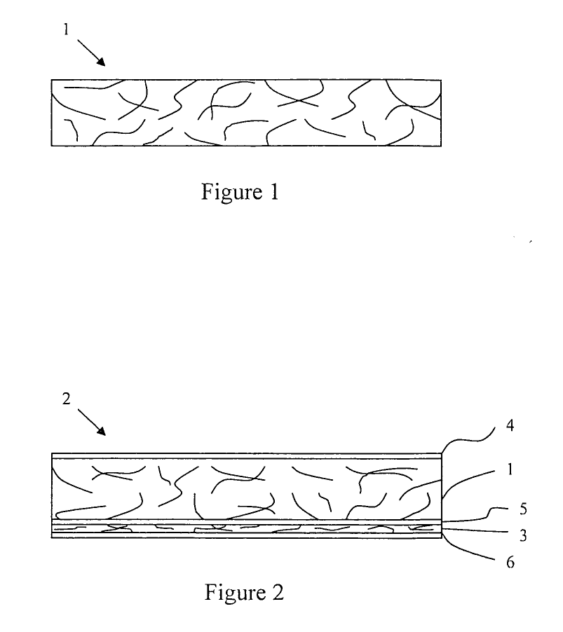

FIG. 1 shows a fire retardant mat 1 according to an embodiment of the invention. In order to form the fire retardant mat 1, a fiber component comprising natural fibers treated with the fire retardant is mixed with a binder to form a blend. The fiber component may be mixed with the binder, for example, by carding and co-mingling the fiber component with the binder in an air stream, which separates the natural fibers from one another and intimately blends the natural fibers with the binder. The blend, or furnish, is then deposited onto a foraminous wire and is compressed to a desired final thickness. Heat is then applied through the fiber web to either melt a thermoplastic binder or cure a thermosetting binder. Alternatively, the blend may be conveyed through an oven that blows heat through the mixture while the mixture is simultaneously being compressed with one or more wire screens.

As previously mentioned, the fiber component includes natural fibers treated with a fire retardant. Bast fibers such as kenaf, hemp, flax, ramie, or jute are examples of natural fibers. The natural fiber ingredient may comprise a single type of fiber or a combination thereof. Additionally, a portion or all of the natural fibers may be recycled fibers. Kenaf, jute, hemp, or combinations thereof are preferred where strength and/or rigidity is sought as these particular fibers are inherently less flexible than other natural fibers.

The fire retardant may be in the form of a powder or liquid and can be, for example, ammonium phosphates, sodium pentaborates, ammonium sulfates, boric acids and mixtures thereof. The fiber component comprises from about 70-99% by dry weight of the mat, and more preferably from about 70 to about 83% by dry weight of the mat. The ratio of the natural fiber to fire retardant in the fiber component is in the range from about 4:1 to about 11.5:1 and more preferably about 5:1.

The amount of binder in the mat in the mat is in the range from about 1 to about 30% by dry weight of the fiber mat. The binder can be either thermoplastic (including bio-based polymers) or thermosetting. For a thermoplastic binder, the material range is more preferably from about 11 to about 30%; most preferably about 13 to about 21%. For a thermosetting binder, the material range is more preferably from about 1 to about 15%; most preferably about 2 to about 8%.

It is well understood in the art that the softening or curing temperature be below the temperature that would cause undesired thermal degradation of the natural fibers. A well known thermoplastic binder fiber is the bi-component sheath-core configuration having a first thermoplastic material coated or encased within a second thermoplastic material having a lower softening temperature. The first thermoplastic material may be, for example, polyethylene terephthalate glycol (PETG), and the second thermoplastic material may be, for example, polyethylene terephthalate (PET).

In the following examples, jute fiber was treated either with a system of ammonium phosphate and borate or with di-ammonium sulfate. The results according to ASTM E 84 for measuring the flame spread and smoke generation index values are shown in Tables 1 and 2. It should be noted that the preferred mat density for use in a ceiling tile structure is in the range from about 4 to about 8 lb/ft³ and, more preferably from about 5 to about 6.5 lb/ft³; most preferably about 5.5 lb/ft³. The preferred thickness of the mat for use in a ceiling tile structure is in the range from about 0.25 to about 2 inches, more preferably about 0.0.375 to about 1.5 inches and most preferably from about 0.4 to about 0.7 inches.

TABLE 1

| | | % of | | | | | | | |
|---|---|---|---|---|---|---|---|---|---|
| | | fibrous | | | Basis | | | Flame- | Smoke |
| | | component | | Binder | Weight | Mat | Mat | spread | Generation |
| | | that is FR | Binder | Amount | of Mat | Thickness | Density | Index | Index |
| Mat | FR | (dry wt %) | Type | (dry wt %) | (g/m2) | (in) | (lb/ft3) | Value | Value |
| 1 | Ammonium | 15 | 110 C. | 15 | 1127 | 0.42 | 6.6 | 25 | 2 |
| | Phosphate/ | | Low- | | | | | | |
| | Borate | | melt | | | | | | |
| | | | Bico | | | | | | |
| 2 | Ammonium | 15 | 110 C. | 18.5 | 923 | 0.528 | 4.3 | 32 | 9 |
| | Phosphate/ | | Low- | | | | | | |
| | Borate | | melt | | | | | | |
| | | | Bico | | | | | | |
| 3 | Ammonium | 15 | 110 C. | 20 | 1145 | 0.512 | 5.5 | 34 | 7 |
| | Phosphate/ | | Low- | | | | | | |
| | Borate | | melt | | | | | | |
| | | | Bico | | | | | | |

TABLE 2

| | | % of | | | | | | | |
|---|---|---|---|---|---|---|---|---|---|
| | | fibrous | | | | | | | |
| | | component | | Binder | Basis | | | Flame- | |
| | | that is | | Amount | Weight | Mat | Mat | spread | Smoke |
| | | FR (dry wt | Binder | (dry wt | of Mat | Thickness | Density | Index | Generation |
| Mat | FR | %) | Type | %) | (g/m2) | (in) | (lb/ft3) | Value | Index Value |
| 4 | Diammonium | 15.6 | 110 C. | 13% | 1472 | 0.62 | 5.8 | 10 | 5-10 |
| | Sulfate | | Low- | | | | | | |
| | | | melt | | | | | | |
| | | | Bico | | | | | | |
| 5 | Diammonium | 15.6 | 110 C. | 15% | 1422 | 0.67 | 5.2 | 10 | 5-10 |
| | Sulfate | | Low- | | | | | | |
| | | | melt | | | | | | |
| | | | Bico | | | | | | |
| 6 | Diammonium | 15.6 | 110 C. | 17% | 1513 | 0.66 | 5.64 | 10 | 10 |
| | Sulfate | | Low- | | | | | | |
| | | | melt | | | | | | |
| | | | Bico | | | | | | |
| 7 | Diammonium | 15.6 | 110 C. | 19% | 1571 | 0.64 | 6.03 | 10 | 10 |
| | Sulfate | | Low- | | | | | | |
| | | | melt | | | | | | |
| | | | Bico | | | | | | |
| 8 | Diammonium | 15.6 | 110 C. | 21% | 1596 | 0.64 | 6.12 | 10 | 10 |
| | Sulfate | | Low- | | | | | | |
| | | | melt | | | | | | |
| | | | Bico | | | | | | |

As shown in Table 1, only sample 1 having a binder level of 15% by wt. of the mat achieved the exceptional Class A fire rating sought when using the system of ammonium phosphate and borate, i.e. a flame spread index reached the 25 value threshold. In contrast when 18.5% bonder or greater was utilized, the flame spread index value was too high. The use of di-ammonium sulfate achieved the exceptional Class A rating both at lower and higher binder levels. Moreover, flame spread index value reached 10 and the smoke generation index value reached 5 when the di-ammonium sulfate was used.

It should be noted that this exceptional Class A fire rating for each of the examples is uniform throughout the entire fire retardant mat 1. What is meant by “uniform throughout the entire fire retardant mat” is that any cross-sectional surface of the fire retardant mat 1 has the same fire rating as any outside surface of the fire retardant mat 1.

A facing scrim 3 and a scrim coating 6 composite was then adhered to sample mats 4-8 of Table 2. The scrim applied to sample mats 4-8 was a fiberglass scrim available from Owens Corning, item number A80PKR-YK111, however, the scrim 3 may be any suitable scrim that is resistant to flame spread and preferably has a Class A fire rating of 25/50, examples of which are fiberglass or flame retardant blends of fiberglass, cellulose and polyester. The fiberglass scrim is bound with a flame retarded polymeric binder. The scrim 3 can be attached to a surface of the fire retardant mat 1 using any suitable attachment method. Here, the fiberglass scrim is affixed to the mat with flame-retarded vinyl-acetate glue 5. The air flow resistance of the A80PKR-YK111 scrim is 40 MKS Rayls.

In the example embodiments set forth above, the scrim was then painted with DURABRITE paint available from Armstrong World Industries. The paint was applied at an application level of 29 g/ft2. What is key for achieving the desired acoustic performance in the fully constructed ceiling panel is that the combination of the scrim, the glue application and the paint application must have an air-flow permeability that allows sound to enter and be absorbed in the structure. A composite air flow resistance of about 400 to about 600 MKS Rayls has been found to achieve an noise reduction coefficient (NRC) greater than 0.80. In order to achieve the desired air flow resistance, and thus, the desired NRC, the scrim weight must be in the range from about 4.5 to about 10.5 g/ft2 and the glue application rate must be in the range from about 3 to about 10 g/ft2 (dry weight). The paint application rate must be in the range from about 10 to about 50 g/ft2 (dry weight).

Table 3 illustrates examples of fully constructed two feet by two feet panels comprising the fire retardant mat samples shown in Table 2.

TABLE 3

| | Binder | | | Flame- | |
|---|---|---|---|---|---|
| | Amount | | Sag | spread | Smoke |
| | in mat | NRC of | Performance | Index of | Index of |
| | (dry wt | Panel | of Panel | Panel | Panel |
| Sample Mat | %) | Structure | Structure | Structure | Structure |
| 4 | 13% | 0.85-0.90 | −162, −224 | 0 | 0 |
| 5 | 15% | 0.85-0.90 | −150 | 10 | 5 |
| 6 | 17% | 0.85 | −128 | 10/5 | 5/0 |
| 7 | 19% | N.D. | N.D. | | |
| 8 | 21% | N.D. | N.D. | | |

The completed structural panels utilizing sample mates 4-8 were indeed found to obtain the desired fire resistance, sag and acoustical properties. Specifically, a completed structural panel achieved a noise reduction coefficient (NRC) of at least 0.85. The noise reduction coefficient (NRC) is a useful indicator of the acoustical properties of a given material. The Noise Reduction Coefficient (NRC) is a scalar representation of the amount of sound energy absorbed upon striking a particular surface. It is well known in the art that NRC is the average of four sound absorption coefficients of the particular surface at frequencies of 250 Hz, 500 Hz, 1000 Hz, and 2000 Hz.

In addition, the desired sag performance was also achieved; namely a statistical value more positive than negative 0.150 inches. To measure the sag performance, several 2×2 inch panels were suspended horizontally from a perimeter support frame and deflection was measured over the course of four 24-hour cycles in which relative humidity was varied: namely 8 hours at 90% relative humidity and then 6 hours at 35% relative humidity. The negative most deflection from horizontal was recorded for each panel formulation. Statistically, an average negative value minus 2 standard deviations that is more negative than negative 0.150 inches represents a threshold performance value for a 2×2 panel at which the sag in the middle of the panel becomes apparent and begins to show an unsightly pillowed appearance in a horizontal installation.

The foregoing illustrates some of the possibilities for practicing the invention. Many other embodiments are possible within the scope and spirit of the invention. For example, although the fire retardant mat 1 is shown and described herein as being incorporated in the ceiling tile structure 2, it will be appreciated by those skilled in the art, however, that the fire retardant mat 1 may have other applications, for example, in the building, furniture, or automotive industry. It is, therefore, intended that the foregoing description be regarded as illustrative rather than limiting, and that the scope of the invention is given by the appended claims together with their full range of equivalents.

We claim:

1. A ceiling tile structure comprising:
a fire retardant mat and a scrim attached to a surface thereof, wherein the fire retardant mat comprises a binder and a fiber component, the fiber component including natural fibers treated with a fire retardant material, the fire retardant mat having a fire rating that is uniform throughout all planes of the fire retardant mat, and wherein the fire rating includes a flame spread index value of 25 or less and a smoke generation index value of 50 or less, as measured by ASTM E 84.

2. The ceiling tile structure of claim 1, comprising a coating on a surface of the fire retardant mat opposite the scrim.

3. The ceiling tile structure of claim 1, comprising a coating on a surface of the scrim opposite the surface of the scrim positioned next to the fire retardant mat.

4. The ceiling tile structure of claim 1, wherein the flame spread index value is 10 or less and the smoke generation index value is 10 or less, as measured by ASTM E 84.

5. The ceiling tile structure of claim 1, wherein the fire retardant material is di-ammonium sulfate.

6. The ceiling tile structure of claim 5, wherein the flame spread index value is 10 or less and the smoke generation index value is 10 or less, as measured by ASTM E 84.

7. The ceiling tile structure of claim 1, wherein the density of the fire retardant mat in the range from about 4 to about 8 lb/ft3.

8. The ceiling tile structure of claim 1, wherein the thickness of the fire retardant mat in the range from about 0.25 to about 2 inches.
